(19) United States
(12) Patent Application Publication
(10) Pub. No.: US 2026/0162164 A1
(43) Pub. Date: Jun. 11, 2026

(54) SHOPPING INTERACTION METHOD AND RELATED PRODUCTS THEREOF

(71) Applicants: Nanjing Xiyin Ecommerce Co., Ltd., Jiangsu (CN); Guangzhou Xiyin International Import and Export Co., Ltd., Guangdong (CN); Shenzhen Xiyin Information Technology Co., Ltd., Guangdong (CN)

(72) Inventor: LI XIAO, Jiangsu (CN)

(21) Appl. No.: 19/174,017

(22) Filed: Apr. 9, 2025

(30) Foreign Application Priority Data
Dec. 11, 2024 (CN) 202411825158.2

(51) Int. Cl. G06Q 30/0601

(52) U.S. Cl. CPC G06Q 30/0631; G06Q 30/0633; G06Q 30/0643

(57) ABSTRACT

A shopping interaction method includes determining, based on an add-to-cart duration of each add-to-cart item in an add-to-cart list, whether the add-to-cart item is a stranded item, and determining whether there is a new item similar to the stranded item, in response to determining that there is a new item similar to the stranded item on a real-time add-to-cart interface, displaying a prompt box at an item column area of the stranded item on the real-time add-to-cart interface, and in response to a new item display instruction input by a user to the prompt box, displaying a new item pushing page on the real-time add-to-cart interface.

### CROSS-REFERENCE TO RELATED APPLICATION AND CLAIM OF PRIORITY

This application claims the benefit under 35 USC § 119 of Chinese Patent Application No. 202411825158.2 filed on Dec. 11, 2024 in the China Intellectual Property Office, the entire disclosure of which is incorporated herein by reference for all purposes.

### BACKGROUND

### 1. Technical Field

The present application generally relates to the technical field of electronic commerce. More specifically, the present application relates to a shopping interaction method and related products thereof.

### 2. Background Art

During shopping online, the shopping cart function allows a user to add selected items into a virtual cart, so that the user can conveniently pay for a plurality of items together at one time. The user can modify the number of items or delete an item at any time, and save information of the selected items before paying. This online shopping cart function not only improves the shopping convenience, but also allows the user to flexibly select items among different shops and complete the shopping in a single payment at the end.

However, after adding an item into the cart, the user may not pay for it for a long time, the reason of which may be that the user wants to further compare the styles or prices, or the like, and then forgets to pay for the item after a long time. Therefore, there is a need to remind the user of an item that is not paid for a long time in the cart, so as to attract the user to pay.

In view of this, there is an urgent need to provide a shopping interaction method which can prompt a user that there is a stranded item which is not paid for a long time in the cart, while recommending new items similar to the stranded item to the user, so that the user can be attracted to complete payment, and the business level of the e-shop can be improved.

### SUMMARY

To address at least one or more of the above technical problems, the present application proposes, in various aspects, a shopping interaction method and related products thereof. The shopping interaction method can prompt a user that there is a stranded item which is not paid for a long time in the cart, while recommending new items similar to the stranded item to the user, so that the user can be attracted to complete payment, and the business level of the e-shop can be improved.

In a first aspect, the present application provides a shopping interaction method, including: determining, based on an add-to-cart duration of each add-to-cart item in an add-to-cart list, whether the add-to-cart item is a stranded item, and determining whether there is a new item similar to the stranded item; in response to determining that there is a new item similar to the stranded item on a real-time add-to-cart interface, displaying a prompt box at an item column area of the stranded item on the real-time add-to-cart interface; and in response to a new item display instruction input by a user to the prompt box, displaying a new item pushing page on the real-time add-to-cart interface.

In some embodiments, in response to determining that there is a new item similar to the stranded item on the real-time add-to-cart interface, displaying the prompt box at the item column area of the stranded item on the real-time add-to-cart interface includes: in response to determining that there is a new item similar to a first stranded item on the real-time add-to-cart interface, displaying a bubble prompt box on an edge of the item column area of the first stranded item on the real-time add-to-cart interface.

In some embodiments, determining, based on the add-to-cart duration of each add-to-cart item in the add-to-cart list, whether the add-to-cart item is a stranded item includes: monitoring the add-to-cart duration of each add-to-cart item in the add-to-cart list; and if the add-to-cart duration of the add-to-cart item is longer than a preset duration, determining that the add-to-cart item is a stranded item.

In some embodiments, determining whether there is a new item similar to the stranded item includes: determining whether there is a new item similar to the stranded item based on an item description label, an item listing duration, preset item exclusions and user feedback filtering items.

In some embodiments, determining whether there is a new item similar to the stranded item based on the item description label, the item listing duration, the preset item exclusions and the user feedback filtering items includes: if a coincidence degree of an item description label of a current item and an item description label of the stranded item is greater than a preset coincidence percentage, an item listing duration of the current item is less than a preset listing duration, and the current item does not belong to the preset item exclusions and the user feedback filtering items, determining that the current item is a new item similar to the stranded item.

In some embodiments, in response to the new item display instruction input by the user to the prompt box, displaying the new item pushing page on the real-time add-to-cart interface includes: in response to a new item display instruction generated by the user clicking a new item viewing button in the bubble prompt box, displaying a new item pushing page on the real-time add-to-cart interface.

In some embodiments, after displaying the new item pushing page on the real-time add-to-cart interface, the method further includes: in response to a new item add-to-cart instruction generated by the user clicking an add-to-cart button corresponding to a target new item in the new item pushing page, displaying an add-to-cart option page on the new item pushing page; in response to a new item add-to-list instruction generated by the user clicking an add-to-list button in the add-to-cart option page, adding the target new item into the add-to-cart list; and if the target new item is successfully added into the add-to-cart list, closing the add-to-cart option page and determining whether to close the new item pushing page based on the number of remaining target new items.

In some embodiments, after adding the target new item into the add-to-cart list, the method further includes: if the number of add-to-cart target new items is greater than a limit and/or the number of remaining target new items is zero when the target new item is to be added into the add-to-cart list, determining that the target new item is failed to be added into the add-to-cart list; otherwise, determining that the target new item is successfully added into the add-to-cart list.

In some embodiments, determining whether to close the new item pushing page based on the number of remaining target new items includes: if the number of remaining target new items is zero, determining to close the new item pushing page and displaying an add-to-cart succeeded prompt on the real-time add-to-cart interface; and if the number of remaining target new items is greater than zero, determining to reserve the new item pushing page and updating a button identifier of the add-to-cart button corresponding to the target new item from an add-to-cart identifier to an add-to-cart number identifier, and displaying the add-to-cart succeeded prompt in the new item pushing page.

In a second aspect, the present application provides a device for shopping interaction, including: a memory; and at least one processor configured to: determine, based on an add-to-cart duration of each add-to-cart item in an add-to-cart list, whether the add-to-cart item is a stranded item, and determine whether there is a new item similar to the stranded item; in response to determining that there is a new item similar to the stranded item on a real-time add-to-cart interface, display a prompt box at an item column area of the stranded item on the real-time add-to-cart interface; and in response to a new item display instruction input by a user to the prompt box, display a new item pushing page on the real-time add-to-cart interface.

In a third aspect, the present application provides a non-transitory machine-readable medium having a program code for shopping interaction stored thereon which, when executed by at least one processor, directs the at least one processor to perform operations of: determining, based on an add-to-cart duration of each add-to-cart item in an add-to-cart list, whether the add-to-cart item is a stranded item, and determining whether there is a new item similar to the stranded item; in response to determining that there is a new item similar to the stranded item on a real-time add-to-cart interface, displaying a prompt box at an item column area of the stranded item on the real-time add-to-cart interface; and in response to a new item display instruction input by a user to the prompt box, displaying a new item pushing page on the real-time add-to-cart interface.

The technical solutions provided in the present application may achieve the following beneficial effects:

According to the shopping interaction method and the related products thereof provided in the present application, by determining, based on an add-to-cart duration of each add-to-cart item in an add-to-cart list, whether the add-to-cart item is a stranded item, and determining whether there is a new item similar to the stranded item, and further by displaying a prompt box at an item column area of the stranded item on the real-time add-to-cart interface in response to determining that there is a new item similar to the stranded item on a real-time add-to-cart interface, it is possible to prompt a user that there is a stranded item which is not paid for a long time in the cart, thereby facilitating earlier payment of the stranded item in the cart.

Furthermore, the present application can display a new item pushing page on the real-time add-to-cart interface in response to a new item display instruction input by a user to the prompt box. Therefore, new items similar to the stranded item can be recommended to the user, so that the user has more options on items and can be attracted to buy an item.

In general, the present application can prompt a user that there is a stranded item which is not paid for a long time in the cart, while recommending new items similar to the stranded item to the user, so that the user can be attracted to complete payment, and the business level of the e-shop can be improved.

### BRIEF DESCRIPTION OF THE DRAWINGS

The above and other objectives, features and advantages of exemplary implementations of the present application will become readily apparent from the following detailed description, which proceeds with reference to the accompanying drawings. In the accompanying drawings, several implementations of the present application are illustrated by way of example but not limitation, and like or corresponding reference numerals indicate like or corresponding parts, in which:

FIG. 1 shows an exemplary flowchart of a shopping interaction method according to some embodiments of the present application;

FIG. 2 shows an exemplary flowchart of a shopping interaction method according to some other embodiments of the present application;

FIG. 3 shows an exemplary flowchart of a shopping interaction method according to yet other embodiments of the present application;

FIG. 4 shows an example of displaying a prompt box in a shopping interaction method according to an embodiment of the present application;

FIG. 5 shows an example of displaying a new item pushing page in a shopping interaction method according to an embodiment of the present application; and

FIG. 6 shows a block diagram of hardware configuration of a device 600 for shopping interaction for implementing the shopping interaction method according to an embodiment of the present application.

### DETAILED DESCRIPTION

The technical solutions in the embodiments of the present application will be clearly and completely described below with reference to the accompanying drawings in the embodiments of the present application. Apparently, the described embodiments are only part, but not all, of the embodiments of the present application. For simplicity and clarity of illustration, where considered appropriate, reference numerals may be repeated among the figures to indicate corresponding or analogous elements. In addition, the present application sets forth numerous specific details to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Moreover, the description should not be taken as limiting the scope of the embodiments described herein. All other embodiments obtained by a person skilled in the art based on the embodiments in the present application without making any creative effort belong to the protection scope of the present application.

It should be understood that the possible terms “first” or “second” or the like in the claims, description and drawings disclosed in the present application are used to distinguish different objects, and are not used to describe a particular order. The terms “comprise” and “include”, when used in the description and claims of the present application, specify the presence of the stated features, integers, steps, operations, elements, and/or components, but do not preclude the presence or addition of one or more other features, integers, steps, operations, elements, components, and/or groups thereof.

It is also to be understood that the terminology used in the description of the present application herein is for the purpose of describing particular embodiments only, and is not intended to limit the present application. As used in the specification and claims of the present application, the singular forms “a”, “an” and “the” are intended to include the plural forms as well, unless the context clearly indicates otherwise. It should be further understood that the term “and/or” as used in the description and claims of the present application refers to any and all possible combinations of one or more of the associated listed items and includes such combinations.

As used in the description and the claims, the term “if” may be interpreted contextually as “when . . . ” or “once” or “in response to determining” or “in response to detecting”. Similarly, the phrase “if it is determined” or “if [the described condition or event] is detected” may be interpreted contextually as meaning “upon determining” or “in response to determining” or “upon detecting [the described condition or event]” or “in response to detecting [the described condition or event]”.

After adding an item into the cart, the user may not pay for it for a long time, the reason of which may be that the user wants to further compare the styles or prices, or the like, and then forgets to pay for the item after a long time. Therefore, there is a need to remind the user of an item that is not paid for a long time in the cart, so as to attract the user to pay.

In view of this, there is an urgent need to provide a shopping interaction method which can prompt a user that there is a stranded item which is not paid for a long time in the cart, while recommending new items similar to the stranded item to the user, so that the user can be attracted to complete payment, and the business level of the e-shop can be improved.

Specific implementations of the present application will be described in detail below with reference to the accompanying drawings.

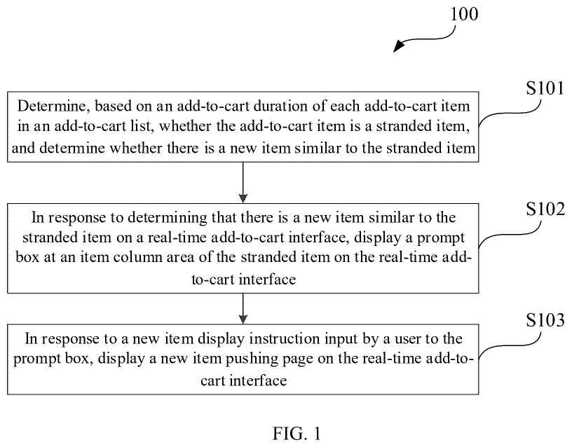

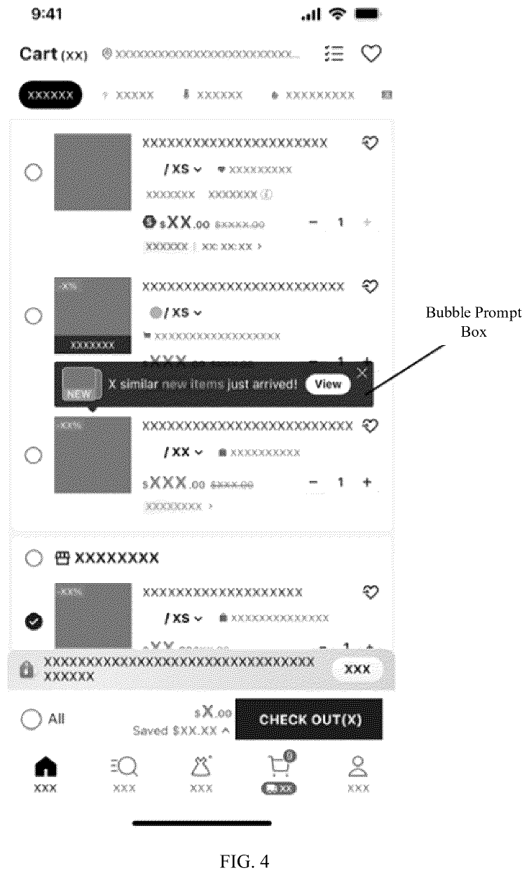

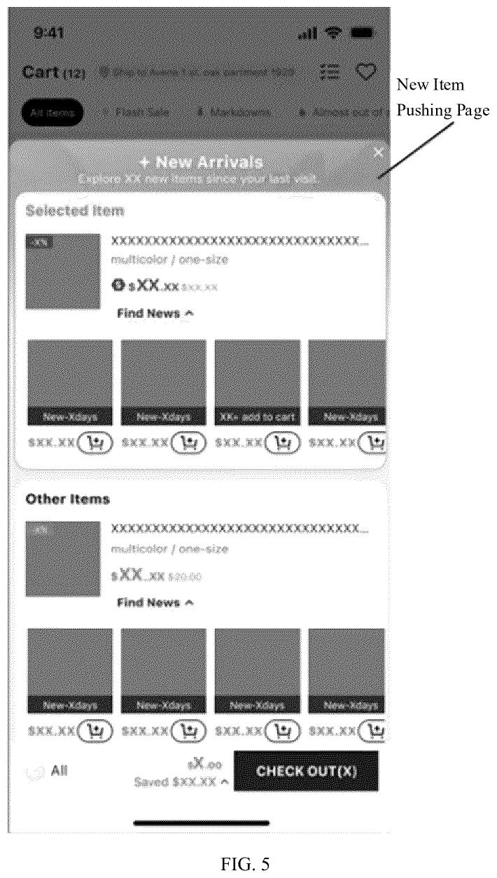

FIG. 1 shows an exemplary flowchart 100 of a shopping interaction method according to some embodiments of the present application, FIG. 4 shows an example of displaying a bubble prompt box in a shopping interaction method according to an embodiment of the present application, and FIG. 5 shows an example of displaying a new item pushing page in a shopping interaction method according to an embodiment of the present application. Referring to FIGS. 1, 4 and 5, a shopping interaction method according to an embodiment of the present application may include the following steps S101 to S103:

At step S101, based on an add-to-cart duration of each add-to-cart item in an add-to-cart list, it is determined whether the add-to-cart item is a stranded item, and whether there is a new item similar to the stranded item. In an embodiment of the present application, the add-to-cart list may refer to a list formed of desired items added into a cart by a user, and each of the desired items forms an add-to-cart item in the add-to-cart list. The add-to-cart duration may be calculated from the time at which an add-to-cart item is added into the add-to-cart list, and, based on the add-to-cart duration of each add-to-cart item, it is possible to judge whether the add-to-cart item is an item stranded in the add-to-cart list for a long time but not paid, so that stranded items in the add-to-cart list can be determined.

Further, in an embodiment of the present application, one or more new items, which have been listed recently, corresponding to each stranded item may be determined. The one or more new items shall be similar to the corresponding stranded item. For example, the similarity between the two may be determined according to an item description label of the stranded item and an item description label of the new item, where the item description label may record, for example, keywords such as an item category and/or feature description.

At step S102, in response to determining that there is a new item similar to the stranded item on a real-time add-to-cart interface, a prompt box is displayed at an item column area of the stranded item on the real-time add-to-cart interface. The prompt box may be displayed at a position of each stranded item having corresponding similar new items on the real-time add-to-cart interface, or displayed at a position of any stranded item having corresponding similar new items on the real-time add-to-cart interface, as shown in FIG. 4, and the prompt box may have a bubble shape. It will be understood that the shape of the prompt box may vary and determined according to the actual application situations in practical applications, which is not limited in any manner in the present application.

At step S103, in response to a new item display instruction input by a user to the prompt box, a new item pushing page is displayed on the real-time add-to-cart interface. In an embodiment of the present application, as shown in FIG. 4, the bubble prompt box may display a new item prompt message and a detail viewing button, so that a user may input a new item display instruction through the detail viewing button, to display a new item pushing page as shown in FIG. 5 on the real-time add-to-cart interface. The new item pushing page may display one or more new items and corresponding prices thereof or the like, so that the user can select and purchase items through the new item pushing page.

In some application scenarios, as shown in FIG. 5, illustratively, the new item pushing page may be divided into a title area, a recommendation area for current stranded item, and a recommendation area for other stranded items. The title area displays information like a title of the new item pushing page, and the number of recommended new items. The recommendation area for current stranded item displays item information and price information of a current stranded item, as well as a first new item slider which displays one or more new items corresponding to the current stranded item. If many new items are provided, more new items can be further displayed by sliding the first new item slider horizontally. The recommendation area for other stranded items displays item information and price information of any stranded item other than the current stranded item, as well as a second new item slider which displays one or more new items corresponding to the selected stranded item. If many new items are provided, more new items can be further displayed by sliding the second new item slider horizontally. In particular, both the first new item slider and the second may be unfolded or hidden as desired by the user.

It will be understood that the area division and the display content of each area in the new item pushing page may vary and determined according to the actual application situations in practical applications, which is not limited in any manner in the present application.

According to the embodiments of the present application, by determining, based on an add-to-cart duration of each add-to-cart item in an add-to-cart list, whether the add-to-cart item is a stranded item, and determining whether there is a new item similar to the stranded item, and further by displaying a bubble prompt box on an edge of the item column area of the first stranded item on the real-time add-to-cart interface in response to determining that there is a new item similar to a first stranded item on the real-time add-to-cart interface, it is possible to prompt a user that there is a stranded item which is not paid for a long time in the cart, thereby facilitating earlier payment of the stranded item in the cart. Furthermore, in some embodiments of the present application, in response to a new item display instruction input by a user to the bubble prompt box, a new item pushing page can be displayed on the real-time add-to-cart interface. Therefore, new items similar to the stranded item can be recommended to the user, so that the user has more options on items and can be attracted to buy an item.

In general, the embodiments of the present application can prompt a user that there is a stranded item which is not paid for a long time in the cart, while recommending new items similar to the stranded item to the user, so that the user can be attracted to complete payment, and the business level of the e-shop can be improved.

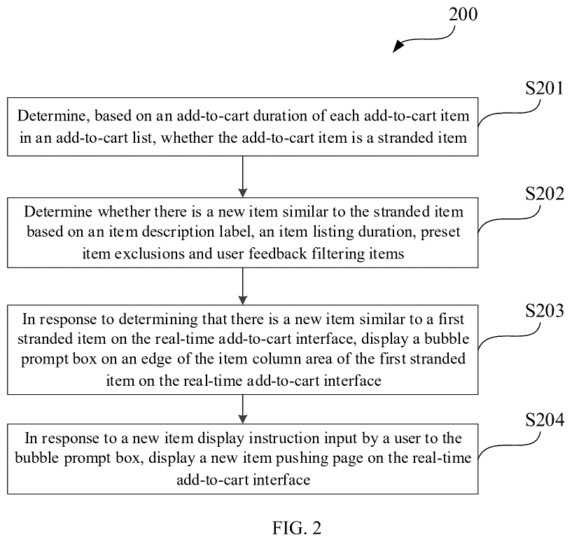

In some embodiments, the overall process of displaying the new item pushing page may be further designed. The process of displaying the new item pushing page will be described in detail below with reference to FIG. 2. FIG. 2 shows an exemplary flowchart 200 of a shopping interaction method according to some other embodiments of the present application. Referring to FIG. 2, a shopping interaction method according to an embodiment of the present application may include the following steps S201 to S204:

At step S201, based on an add-to-cart duration of each add-to-cart item in an add-to-cart list, it is determined whether the add-to-cart item is a stranded item. In an embodiment of the present application, the add-to-cart duration of each add-to-cart item in the add-to-cart list may be monitored and further compared with a preset duration. If the add-to-cart duration of the add-to-cart item is longer than the preset duration, it is determined that the add-to-cart item is a stranded item. The preset duration may be set to 21 natural days. It will be understood that in practical applications, the preset duration may be set in various manners, and determined according to the actual application situations in practical applications, which is not limited in any manner in the present application.

At step S202, it is determined whether there is a new item similar to the stranded item based on an item description label, an item listing duration, preset item exclusions and user feedback filtering items. In an embodiment of the present application, if a coincidence degree of an item description label of a current item and an item description label of the stranded item is greater than a preset coincidence percentage, an item listing duration of the current item is less than a preset listing duration, and the current item does not belong to the preset item exclusions and the user feedback filtering items, it is determined that the current item is a new item similar to the stranded item. It will be understood that one item may have one or more item description labels, and that if the coincidence degree of the item description label of the current item and the item description label of the stranded item is greater than the preset coincidence percentage, it indicates that the current item and the stranded item are similar in category and/or similar in description. The preset coincidence percentage may be set to 50%, and determined according to the actual application situations in practical applications, which is not limited in any manner in the present application.

Further, if the item listing duration of the current item is less than the preset listing duration, it indicates that the current item has been listed for a short period, and thus belongs to newly listed items. The preset listing duration may be set to 7 natural days, and determined according to the actual application situations in practical applications, which is not limited in any manner in the present application.

Further, the preset item exclusions may include, but are not limited to, items not available, infringing items, items out of stock, and the like, while the user feedback filtering items may include, but are not limited to, items not of interest for the user, complaint items by the user, items already purchased by the user, and the like. A current item is recommended to the user only when it does not belong to the above.

At step S203, in response to determining that there is a new item similar to a first stranded item on the real-time add-to-cart interface, a bubble prompt box is displayed on an edge of the item column area of the first stranded item on the real-time add-to-cart interface. In an embodiment of the present application, when it is determined that there is a new item similar to the first stranded item on the real-time add-to-cart interface, as shown in FIG. 4, a bubble prompt box may be displayed on any edge position of the item column area of the first stranded item on the real-time add-to-cart interface, where the item column area refers to an area position for displaying item information in each column of the add-to-cart list. It will be understood that the real-time add-to-cart interface is a real-time interface when a user stops to view in the process of scrolling the add-to-cart list, which will change with scrolling of a screen interface by the user, so that the first stranded item on the real-time add-to-cart interface will also be dynamically changed. In addition, the bubble prompt box refers to a prompt box in a bubble-like form, and which is a common interactive design form for information prompt in the field of interactive design, and may be used to give feedback to a user in real time during operation of a product, and help the user to sense a state of the system at any time. In an embodiment of the present application, the bubble prompt box may have a shape of a rectangle with sharp corners as shown in FIG. 4, or a cloud with sharp corners. In practical applications, the shape of the bubble prompt box may vary and determined according to the actual application situations, which is not limited in any manner in the present application.

At step S204, in response to a new item display instruction input by a user to the bubble prompt box, a new item pushing page is displayed on the real-time add-to-cart interface. In an embodiment of the present application, as shown in FIGS. 4 and 5, a prompt for arrival of a new item may be provided to a user in the bubble prompt box, and a new item viewing button (for example, “view” in FIG. 4) may be provided beside the prompt, so that in response to a new item display instruction generated by the user clicking the new item viewing button in the bubble prompt box, a new item pushing page may be displayed on the real-time add-to-cart interface.

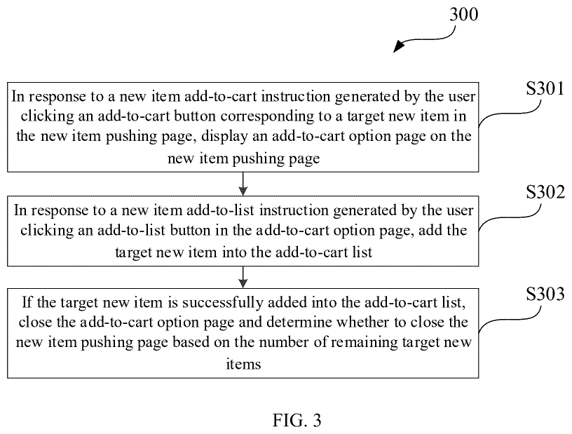

In some embodiments, after the new item pushing page is displayed, the new item add-to-cart process may be further designed. The new item add-to-cart process will be described in detail with reference to FIG. 3. FIG. 3 shows an exemplary flowchart of a shopping interaction method according to yet other embodiments of the present application. Referring to FIG. 3, a shopping interaction method according to an embodiment of the present application may include the following steps S301 to S303:

At step S301, in response to a new item add-to-cart instruction generated by the user clicking an add-to-cart button corresponding to a target new item in the new item pushing page, an add-to-cart option page is displayed on the new item pushing page. It will be understood that in the add-to-cart option page, the user may make selections on item options about the target new item, such as the size, color, number, and the like.

At step S302, in response to a new item add-to-list instruction generated by the user clicking an add-to-list button in the add-to-cart option page, the target new item is added into the add-to-cart list. In an embodiment of the present application, if the number of add-to-cart target new items is greater than a limit and/or the instant number of remaining target new items is zero when the target new item is to be added into the add-to-cart list, it is determined that the target new item is failed to be added into the add-to-cart list, and then the add-to-cart option page may be closed and an add-to-cart failed bubble may be displayed in the new item pushing page. Otherwise, it is determined that the target new item is successfully added into the add-to-cart list.

At step S303, if the target new item is successfully added into the add-to-cart list, the add-to-cart option page is closed and it is determined whether to close the new item pushing page based on the number of remaining target new items. In an embodiment of the present application, if the number of remaining target new items is zero, it is determined to close the new item pushing page and an add-to-cart succeeded prompt is displayed on the real-time add-to-cart interface. If the number of remaining target new items is greater than zero, it is determined to reserve the new item pushing page and a button identifier of the add-to-cart button corresponding to the target new item is updated from an add-to-cart identifier to an add-to-cart number identifier, and the add-to-cart succeeded prompt is displayed in the new item pushing page. It will be understood that the add-to-cart failed bubble and the add-to-cart succeeded prompt are both prompt boxes in a bubble-like form, and text displayed in the bubble can prompt the user that the add-to-cart operation is succeeded or failed.

Corresponding to the embodiments of the application function implementation method described above, the present application further provides a device for shopping interaction and corresponding embodiments thereof.

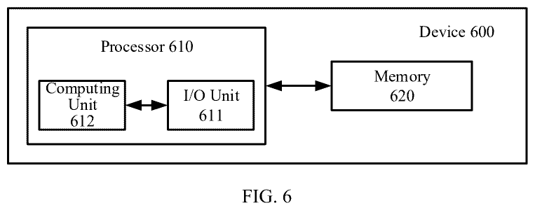

FIG. 6 shows a block diagram of hardware configuration of a device 600 for shopping interaction for implementing the shopping interaction method according to an embodiment of the present application. As shown in FIG. 6, the device 600 for shopping interaction may include a processor 610 and a memory 620. In the device 600 for shopping interaction of FIG. 6, only constituent elements related to the present embodiment are shown. Therefore, it will be apparent to those of ordinary skill in the art that: the device 600 for shopping interaction may further include common constituent elements other than those shown in FIG. 6, a fixed-point arithmetic unit for example.

The device 600 for shopping interaction may correspond to a computing device having various processing functions, such as functions for generation, training or learning of a neural network, for quantizing a floating point type neural network to a fixed point type neural network, or for retraining a neural network. For example, the device 600 for shopping interaction may be implemented as various types of devices, such as a personal computer (PC), a server device, a mobile device, and so on.

The processor 610 controls all functions of the device 600 for shopping interaction. For example, the processor 610 controls all functions of the device 600 for shopping interaction by executing programs stored on the memory 620 in the device 600 for shopping interaction. The processor 610 may be implemented by a central processing unit (CPU), a graphics processing unit (GPU), an application processor (AP), an intelligent processing unit (IPU), and the like provided in the device 600 for shopping interaction. However, the present application is not limited thereto.

In some embodiments, the processor 610 may include an input/output (I/O) unit 611 and a computing unit 612. The I/O unit 611 may be configured to receive various types of data, such as a feature profile issued by a server. Illustratively, the computing unit 612 may be configured to collect real-time feature data based on the feature profile received via the I/O unit 611, store the real-time feature data in a client database, and, in response to a data transfer instruction sent from the server, report and feed back the real-time feature data to the server, so that the server can determine a processing policy based on the real-time feature data. The real-time feature data may be output from the I/O unit 611, for example. The output data may be provided to the memory 620 for reading and use by other devices (not shown), or may be provided directly to other devices for use.

The memory 620 is hardware for storing various data processed in the device 600 for shopping interaction. For example, the memory 620 may store processed data and data to be processed in device 600 for shopping interaction. The memory 620 may store data sets, such as a feature profile issued by a server and the like, involved in implementation of a shopping interaction method processed or to be processed by the processor 610. Further, the memory 620 may store applications, drivers, and the like to be driven by device 600 for shopping interaction. For example: the memory 620 may store various programs related to a shopping interaction method to be executed by the processor 610. The memory 620 may be a DRAM, but the present application is not limited thereto. The memory 620 may include at least one of a volatile memory or a non-volatile memory. The non-volatile memory may include a read-only memory (ROM), a programmable ROM (PROM), an electrically programmable ROM (EPROM), an electrically erasable programmable ROM (EEPROM), a flash, phase-change RAM (PRAM), a magnetic RAM (MRAM), a resistive RAM (RRAM), a ferroelectric RAM (FRAM), or the like. The volatile memory may include a dynamic RAM (DRAM), a static RAM (SRAM), a synchronous DRAM (SDRAM), a PRAM, an MRAM, an RRAM, a ferroelectric RAM (FeRAM), or the like. In an embodiment, the memory 620 may include at least one of a hard disk drive (HDD), a solid state drive (SSD), a compact flash (CF), a secure digital (SD) card, a Micro-SD card, a Mini-SD card, an xD card, a cache, or a memory stick.

In summary, specific functions implemented by the memory 620 and the processor 610 of the device 600 for shopping interaction provided in the implementations of the present disclosure may be explained in comparison with the foregoing implementations in the description of the present disclosure, and can achieve the technical effects of the foregoing implementations, and therefore, no further description is provided herein.

In this implementation, the processor 610 may be implemented in any suitable manner. For example, the processor 610 may take the form of, for example, a microprocessor or processor and a computer-readable medium that stores a computer-readable program code (e.g., software or firmware) executable by the (micro) processor, a logic gate, a switch, an application specific integrated circuit (ASIC), a programmable logic controller, an embedded microcontroller, or the like.

It will also be appreciated that any module, unit, component, server, computer, terminal or device exemplified herein that executes instructions may include or otherwise have access to computer-readable media such as storage media, computer storage media, or data storage devices (removable and/or non-removable) such as, for example, magnetic disks, optical disks or tape. The computer storage medium may include volatile and non-volatile, removable and non-removable media implemented in any method or technology for storage of information, such as computer-readable instructions, data structures, program modules, or the like.

The foregoing may be better understood in light of the following clauses:

Clause A1. A shopping interaction method, including: determining, based on an add-to-cart duration of each add-to-cart item in an add-to-cart list, whether the add-to-cart item is a stranded item, and determining whether there is a new item similar to the stranded item; in response to determining that there is a new item similar to the stranded item on a real-time add-to-cart interface, displaying a prompt box at an item column area of the stranded item on the real-time add-to-cart interface; and in response to a new item display instruction input by a user to the prompt box, displaying a new item pushing page on the real-time add-to-cart interface.

Clause A2. The shopping interaction method of clause A1, wherein in response to determining there is a new item similar to the stranded item on the real-time add-to-cart interface, displaying the prompt box at the item column area of the stranded item on the real-time add-to-cart interface includes: in response to determining that there is a new item similar to a first stranded item on the real-time add-to-cart interface, displaying a bubble prompt box on an edge of the item column area of the first stranded item on the real-time add-to-cart interface.

Clause A3. The shopping interaction method of clause A1, wherein determining, based on the add-to-cart duration of each add-to-cart item in the add-to-cart list, whether the add-to-cart item is a stranded item includes: monitoring the add-to-cart duration of each add-to-cart item in the add-to-cart list; and if the add-to-cart duration of the add-to-cart item is longer than a preset duration, determining that the add-to-cart item is a stranded item.

Clause A4. The shopping interaction method of clause A1, wherein determining whether there is a new item similar to the stranded item includes: determining whether there is a new item similar to the stranded item based on an item description label, an item listing duration, preset item exclusions and user feedback filtering items.

Clause A5. The shopping interaction method of clause A4, wherein determining whether there is a new item similar to the stranded item based on the item description label, the item listing duration, the preset item exclusions and the user feedback filtering items includes: if a coincidence degree of an item description label of a current item and an item description label of the stranded item is greater than a preset coincidence percentage, an item listing duration of the current item is less than a preset listing duration, and the current item does not belong to the preset item exclusions and the user feedback filtering items, determining that the current item is a new item similar to the stranded item.

Clause A6. The shopping interaction method of clause A2, wherein in response to the new item display instruction input by the user to the prompt box, displaying the new item pushing page on the real-time add-to-cart interface includes: in response to a new item display instruction generated by the user clicking a new item viewing button in the bubble prompt box, displaying the new item pushing page on the real-time add-to-cart interface.

Clause A7. The shopping interaction method of clause A1, wherein after displaying the new item pushing page on the real-time add-to-cart interface, the method further includes: in response to a new item add-to-cart instruction generated by the user clicking an add-to-cart button corresponding to a target new item in the new item pushing page, displaying an add-to-cart option page on the new item pushing page; in response to a new item add-to-list instruction generated by the user clicking an add-to-list button in the add-to-cart option page, adding the target new item into the add-to-cart list; and if the target new item is successfully added into the add-to-cart list, closing the add-to-cart option page and determining whether to close the new item pushing page based on the number of remaining target new items.

Clause A8. The shopping interaction method of clause A7, wherein after adding the target new item into the add-to-cart list, the method further includes: if the number of add-to-cart target new items is greater than a limit and/or the number of remaining target new items is zero when the target new item is to be added into the add-to-cart list, determining that the target new item is failed to be added into the add-to-cart list; otherwise, determining that the target new item is successfully added into the add-to-cart list.

Clause A9. The shopping interaction method of clause A7, wherein determining whether to close the new item pushing page based on the number of remaining target new items includes: if the number of remaining target new items is zero, determining to close the new item pushing page and displaying an add-to-cart succeeded prompt on the real-time add-to-cart interface; and if the number of remaining target new items is greater than zero, determining to reserve the new item pushing page and updating a button identifier of the add-to-cart button corresponding to the target new item from an add-to-cart identifier to an add-to-cart number identifier, and displaying the add-to-cart succeeded prompt in the new item pushing page.

Clause A10. a device for shopping interaction, including: a memory; and at least one processor configured to: determine, based on an add-to-cart duration of each add-to-cart item in an add-to-cart list, whether the add-to-cart item is a stranded item, and determine whether there is a new item similar to the stranded item; in response to determining that there is a new item similar to the stranded item on a real-time add-to-cart interface, display a prompt box at an item column area of the stranded item on the real-time add-to-cart interface; and in response to a new item display instruction input by a user to the prompt box, display a new item pushing page on the real-time add-to-cart interface.

Clause A11. A non-transitory machine-readable medium having a program code for shopping interaction stored thereon which, when executed by at least one processor, directs the at least one processor to perform operations of: determining, based on an add-to-cart duration of each add-to-cart item in an add-to-cart list, whether the add-to-cart item is a stranded item, and determining whether there is a new item similar to the stranded item; in response to determining that there is a new item similar to the stranded item on a real-time add-to-cart interface, displaying a prompt box at an item column area of the stranded item on the real-time add-to-cart interface; and in response to a new item display instruction input by a user to the prompt box, displaying a new item pushing page on the real-time add-to-cart interface.

What is claimed is:

1. A shopping interaction method comprising:
determining, based on an add-to-cart duration of each add-to-cart item in an add-to-cart list, whether the add-to-cart item is a stranded item, and determining whether there is a new item similar to the stranded item;
in response to determining that there is a new item similar to the stranded item on a real-time add-to-cart interface, displaying a prompt box at an item column area of the stranded item on the real-time add-to-cart interface; and
in response to a new item display instruction input by a user to the prompt box, displaying a new item pushing page on the real-time add-to-cart interface.

2. The shopping interaction method of claim 1, wherein in response to determining that there is a new item similar to the stranded item on the real-time add-to-cart interface, displaying the prompt box at the item column area of the stranded item on the real-time add-to-cart interface includes:
in response to determining that there is a new item similar to a first stranded item on the real-time add-to-cart interface, displaying a bubble prompt box on an edge of the item column area of the first stranded item on the real-time add-to-cart interface.

3. The shopping interaction method of claim 1, wherein determining, based on the add-to-cart duration of each add-to-cart item in the add-to-cart list, whether the add-to-cart item is a stranded item includes:
monitoring the add-to-cart duration of each add-to-cart item in the add-to-cart list; and
if the add-to-cart duration of the add-to-cart item is longer than a preset duration, determining that the add-to-cart item is a stranded item.

4. The shopping interaction method of claim 1, wherein determining whether there is a new item similar to the stranded item includes:
determining whether there is a new item similar to the stranded item based on an item description label, an item listing duration, preset item exclusions and user feedback filtering items.

5. The shopping interaction method of claim 4, wherein determining whether there is a new item similar to the stranded item based on the item description label, the item listing duration, the preset item exclusions and the user feedback filtering items includes:
if a coincidence degree of an item description label of a current item and an item description label of the stranded item is greater than a preset coincidence percentage, an item listing duration of the current item is less than a preset listing duration, and the current item does not belong to the preset item exclusions and the user feedback filtering items, determining that the current item is a new item similar to the stranded item.

6. The shopping interaction method of claim 2, wherein in response to the new item display instruction input by the user to the prompt box, displaying the new item pushing page on the real-time add-to-cart interface includes:
in response to a new item display instruction generated by the user clicking a new item viewing button in the bubble prompt box, displaying the new item pushing page on the real-time add-to-cart interface.

7. The shopping interaction method of claim 1, wherein after displaying the new item pushing page on the real-time add-to-cart interface, the method further includes:
in response to a new item add-to-cart instruction generated by the user clicking an add-to-cart button corresponding to a target new item in the new item pushing page, displaying an add-to-cart option page on the new item pushing page;
in response to a new item add-to-list instruction generated by the user clicking an add-to-list button in the add-to-cart option page, adding the target new item into the add-to-cart list; and
if the target new item is successfully added into the add-to-cart list, closing the add-to-cart option page and determining whether to close the new item pushing page based on the number of remaining target new items.

8. The shopping interaction method of claim 7, wherein after adding the target new item into the add-to-cart list, the method further includes:
if the number of add-to-cart target new items is greater than a limit and/or the number of remaining target new items is zero when the target new item is to be added into the add-to-cart list, determining that the target new item is failed to be added into the add-to-cart list; otherwise, determining that the target new item is successfully added into the add-to-cart list.

9. The shopping interaction method of claim 7, wherein determining whether to close the new item pushing page based on the number of remaining target new items includes:
if the number of remaining target new items is zero, determining to close the new item pushing page and displaying an add-to-cart succeeded prompt on the real-time add-to-cart interface; and
if the number of remaining target new items is greater than zero, determining to reserve the new item pushing page and updating a button identifier of the add-to-cart button corresponding to the target new item from an add-to-cart identifier to an add-to-cart number identifier, and displaying the add-to-cart succeeded prompt in the new item pushing page.

10. A device for shopping interaction, comprising:
a memory; and
at least one processor configured to:
determine, based on an add-to-cart duration of each add-to-cart item in an add-to-cart list, whether the add-to-cart item is a stranded item, and determine whether there is a new item similar to the stranded item;
in response to determining that there is a new item similar to the stranded item on a real-time add-to-cart interface, display a prompt box at an item column area of the stranded item on the real-time add-to-cart interface; and
in response to a new item display instruction input by a user to the prompt box, display a new item pushing page on the real-time add-to-cart interface.

11. The device of claim 10, wherein the processor is further configured to:
in response to determining that there is a new item similar to a first stranded item on the real-time add-to-cart interface, display a bubble prompt box on an edge of the item column area of the first stranded item on the real-time add-to-cart interface.

12. The device of claim 10, wherein the processor is further configured to:
monitor the add-to-cart duration of each add-to-cart item in the add-to-cart list; and
if the add-to-cart duration of the add-to-cart item is longer than a preset duration, determine that the add-to-cart item is a stranded item.

13. The device of claim 10, wherein the processor is further configured to:
determine whether there is a new item similar to the stranded item based on an item description label, an item listing duration, preset item exclusions and user feedback filtering items.

14. The device of claim 13, wherein the processor is further configured to:
if a coincidence degree of an item description label of a current item and an item description label of the stranded item is greater than a preset coincidence percentage, an item listing duration of the current item is less than a preset listing duration, and the current item does not belong to the preset item exclusions and the user feedback filtering items, determine that the current item is a new item similar to the stranded item.

15. The device of claim 11, wherein the processor is further configured to:
in response to a new item display instruction generated by the user clicking a new item viewing button in the bubble prompt box, display the new item pushing page on the real-time add-to-cart interface.

16. The device of claim 10, wherein the processor is further configured to, after displaying the new item pushing page on the real-time add-to-cart interface:
in response to a new item add-to-cart instruction generated by the user clicking an add-to-cart button corresponding to a target new item in the new item pushing page, display an add-to-cart option page on the new item pushing page;
in response to a new item add-to-list instruction generated by the user clicking an add-to-list button in the add-to-cart option page, add the target new item into the add-to-cart list; and
if the target new item is successfully added into the add-to-cart list, close the add-to-cart option page and determine whether to close the new item pushing page based on the number of remaining target new items.

17. The device of claim 16, wherein the processor is further configured to, after adding the target new item into the add-to-cart list:
if the number of add-to-cart target new items is greater than a limit and/or the number of remaining target new items is zero when the target new item is to be added into the add-to-cart list, determine that the target new item is failed to be added into the add-to-cart list; otherwise, determine that the target new item is successfully added into the add-to-cart list.

18. The device of claim 16, wherein the processor is further configured to:
if the number of remaining target new items is zero, determine to close the new item pushing page and display an add-to-cart succeeded prompt on the real-time add-to-cart interface; and
if the number of remaining target new items is greater than zero, determine to reserve the new item pushing page and update a button identifier of the add-to-cart button corresponding to the target new item from an add-to-cart identifier to an add-to-cart number identifier, and display the add-to-cart succeeded prompt in the new item pushing page.

19. A non-transitory machine-readable medium having a program code for shopping interaction stored thereon which, when executed by at least one processor, directs the at least one processor to perform operations of:
determining, based on an add-to-cart duration of each add-to-cart item in an add-to-cart list, whether the add-to-cart item is a stranded item, and determining whether there is a new item similar to the stranded item;
in response to determining that there is a new item similar to the stranded item on a real-time add-to-cart interface, displaying a prompt box at an item column area of the stranded item on the real-time add-to-cart interface; and
in response to a new item display instruction input by a user to the prompt box, displaying a new item pushing page on the real-time add-to-cart interface.
